(19) United States
(12) Patent Application Publication
(10) Pub. No.: US 2006/0285164 A1
(43) Pub. Date: Dec. 21, 2006

(54) Method for Processing Multi-layered Image Data

(76) Inventor: Chun-Yi Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,216

(22) Filed: Oct. 11, 2005

(30) Foreign Application Priority Data
Jun. 21, 2005 (TW) 094120673

(51) Int. Cl. G06F 15/00

(52) U.S. Cl. 358/3.01; 358/1.9

(57) ABSTRACT

A method for processing multi-layered image data by utilizing a modified alpha blending algorithm. The method includes detecting whether mask values of image data are within a predetermined range and generating new image data according to the image data and the mask values. An image processing device capable of adding shaded diagrams or frames to a camera preview picture and presenting display selections, diagrams, special effects, or backgrounds simultaneously on a limited display screen of a handheld electronic device.

### BACKGROUND OF THE INVENTION

1. Field of the Invention

The present invention provides a method for processing multi-layered image data, more particularly a method for processing multi-layered image data by utilizing a modified alpha blending algorithm.

2. Description of the Prior Art

In a camera preview module of the handheld device, in addition to the preview screen, the user will frequently utilize the user interface (selection or picture setup and so on) to add special effects, frame, or other designs. Please refer to FIG. 1 through FIG. 4. FIG. 1 illustrates a diagram of a camera preview picture 10 combining with an opaque picture 12 under a camera preview module of a conventional handheld device. FIG. 2 illustrates a diagram of the picture of FIG. 1 combining with an opaque screen of an opaque selection 14. FIG. 3 illustrates a diagram of a camera preview picture 10 combining with an opaque frame 16 under a camera preview module of a conventional handheld device. FIG. 4 illustrates a diagram of a camera preview picture 10 combining with an opaque picture 12, an opaque selection 14, an opaque frame 16 under a camera preview module of a conventional handheld device. In general, in a camera preview module of a handheld device with a camera, the camera preview scenes of the above-mentioned usually occurs, which means that besides the camera preview picture 10 captured by the camera, extra selection, picture, special effect or background can be added within the preview screen. However, as a result in the overlapping of the camera preview picture 10, the opaque picture 12, the opaque selection 14, and the opaque frame 16, only one image can be displayed, therefore in the limited display picture as the extra selection, the picture, the special effect, or the background can cover the camera preview picture 10 which creates the preview image area to become smaller. The conventional preview picture will appear to be monotonous which lacks of diverse visual effects, hence the application of the ever-changing handheld device is otherwise perfect except for this minor defect.

### SUMMARY OF THE INVENTION

The claimed invention provides a method for processing multi-layered image data by utilizing a modified alpha blending algorithm to solve the above-mentioned problem.

The claimed invention discloses a method for processing multi-layered image data, the method comprises the following steps: detecting whether a mask value of a first image data is within a predetermined range, and generating a third image data when the mask value of the first image data is within the predetermined range according to the first image data, a second image data, and a mask value of the second image data.

The claimed invention discloses a method for processing multi-layered image data, the method comprises the following steps: detecting whether a mask value of a first image data is within a predetermined range, and generating a third image data when the mask value of the first image data is outside the predetermined range according to the first image data, a second image data, and the mask value of the first image data.

The claimed invention discloses a mobile communication device capable of processing multi-layered image data, the mobile communication device comprises a memory for storing a first image data and a second image data, a logic unit coupled to the memory for determining whether a mask value of the first image is within a predetermined range, and for generating a third image data when the mask value of the first image data is within the predetermined range according to the first image data, the second image data, and a mask value of the second image data, and a display module coupled to the logic unit for displaying an image data.

The claimed invention discloses a mobile communication device capable of processing multi-layered image data, the mobile communication device comprises a memory for storing a first image data and a second image data, a display module for displaying an image data, and a logic unit for determining whether a mask value of the first image data is within a predetermined range, and for generating a third image data when the mask value of the first image data is outside the predetermined range according to the first image data, the second image data, and the mask value of the first image data.

The claimed invention discloses an image processing device capable of processing multi-layered image data, the image processing device comprises a memory for storing a first image data and a second image data, a display module for displaying an image data, and a logic unit for determining whether a mask value of the first image is within a predetermined range, and for generating a third image data when the mask value of the first image data is within the predetermined range according to the first image data, the second image data, and a mask value of the second image data

The claimed invention discloses an image processing device capable of processing multi-layered image data, the image processing device comprises a memory for storing a first image data and a second image data, a display module for displaying an image data, a logic unit for determining whether a mask value of the first image data is within a predetermined range, and for generating a third image data when the mask value of the first image data is outside the predetermined range according to the first image data, the second image data, and the mask value of the first image data, and a display module coupled to the logic unit for displaying an image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a camera preview picture combining with an opaque picture under a camera preview module of a conventional handheld device in a prior art.

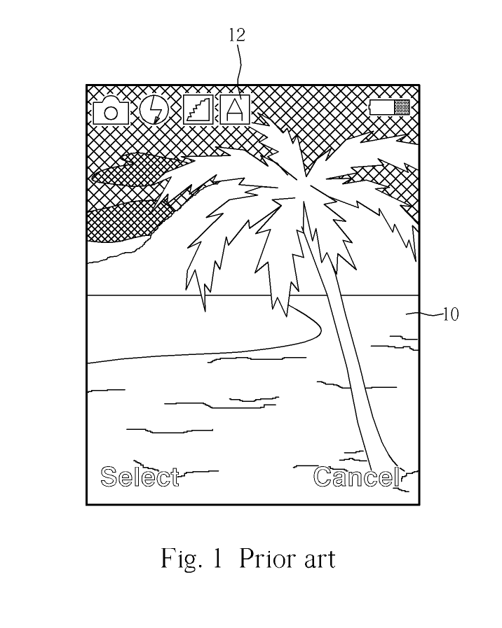

FIG. 2 illustrates a diagram of the picture of FIG. 1 combining with an opaque screen of an opaque selection.

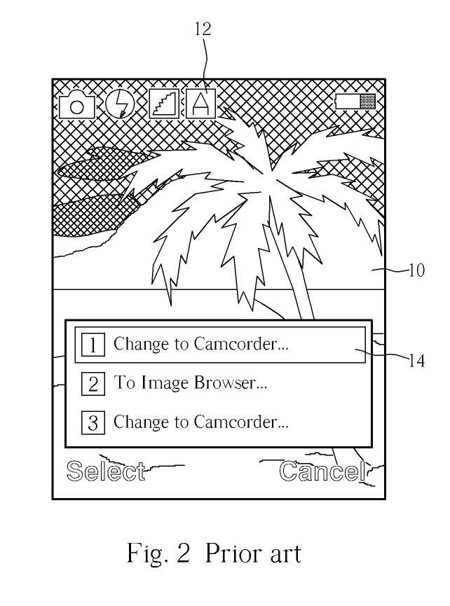

FIG. 3 illustrates a diagram of a camera preview picture combining with an opaque frame under a camera preview module of a conventional handheld device in a prior art.

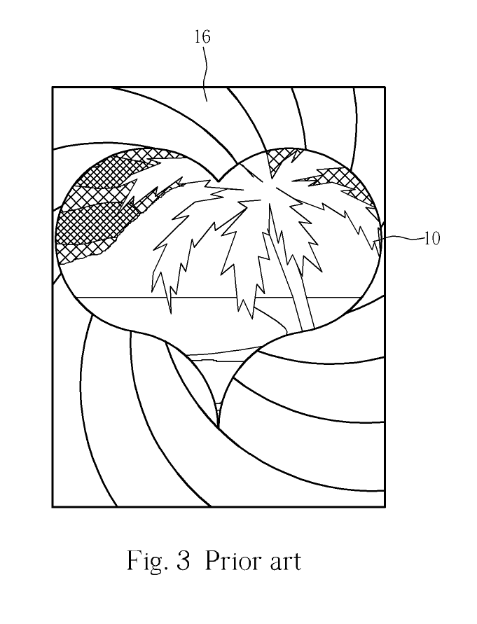

FIG. 4 illustrates a diagram of a camera preview picture combining with an opaque picture, an opaque selection, an opaque frame under a camera preview module of a conventional handheld device in a prior art.

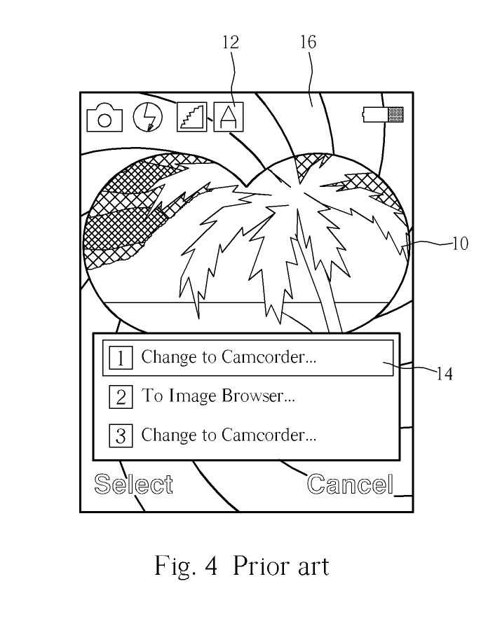

FIG. 5 illustrates a functional block diagram of a mobile communication device according to the present invention.

FIG. 6 illustrates a screen diagram of a first image according to the present invention.

FIG. 7 illustrates a screen diagram of a second image according to the present invention.

FIG. 8 illustrates a screen diagram of a third image according to the present invention.

FIG. 9 illustrates a screen diagram of a fourth image according to the present invention.

FIG. 10 illustrates a screen diagram of a fifth image according to the present invention.

FIG. 11 illustrates a flowchart of processing multi-layered image data according to the present invention.

FIG. 12 illustrates a flowchart of processing multi-layered image data according to the present invention.

FIG. 13 illustrates a screen diagram of a sixth image according to the present invention.

FIG. 14 illustrates a screen diagram of a seventh image according to the present invention.

FIG. 15 illustrates a screen diagram of an eighth image according to the present invention.

FIG. 16 illustrates a screen diagram of a ninth image according to the present invention.

FIG. 17 illustrates an architecture diagram of the present invention processing multi-layered image data.

### DETAILED DESCRIPTION

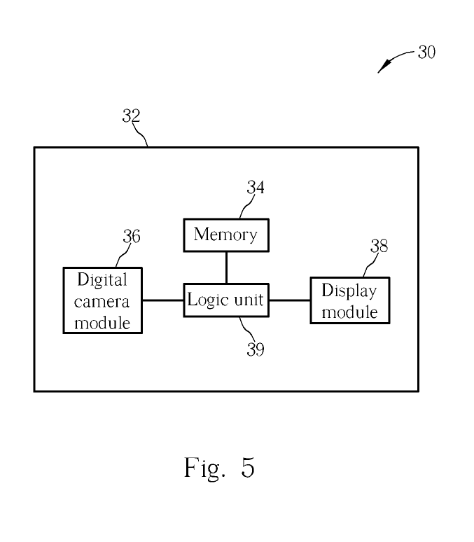

Please refer FIG. 5. FIG. 5 illustrates a functional block diagram of a mobile communication device 30 according to the present invention. The mobile communication device 30 is a mobile phone. The mobile communication device 30 comprises a housing 32 for enclosing internal components of the mobile communication device 30, a memory 34 installed within the housing 32, for storing image data, a digital camera module 36 for capturing images of scenery, a display module 38 for displaying the image data, the display module 38 is a liquid-crystal display (LCD), and a logic unit 39 installed in the housing 32, for calculating a final output image to be presented on the display module 38 according to the image data stored in the memory 34. The logic unit 39 can also comprise a program code for providing an algorithm in a software to calculate a final output image.

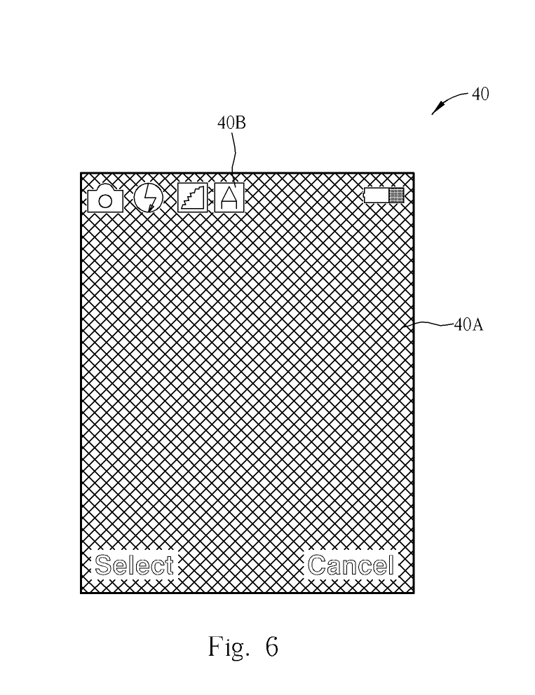

Please refer FIG. 6. FIG. 6 illustrates a screen diagram of a first image 40 according to the present invention. A background 40A of the first image 40 can be a single color, for example, a blue color, where its setting is transparent, in other words part of the single color background 40A will be replaced by a camera preview picture, but the first image 40 further comprises a plurality of pictures 40B having a degree of opacity, the picture 40B can be a combination of an opaque color (in this embodiment: blue), in other words the picture 40B cannot be replaced by the camera preview picture. Furthermore, the picture 40B can display the current state of the mobile communication device 30 such as the battery capacity or the signal intensity and so on.

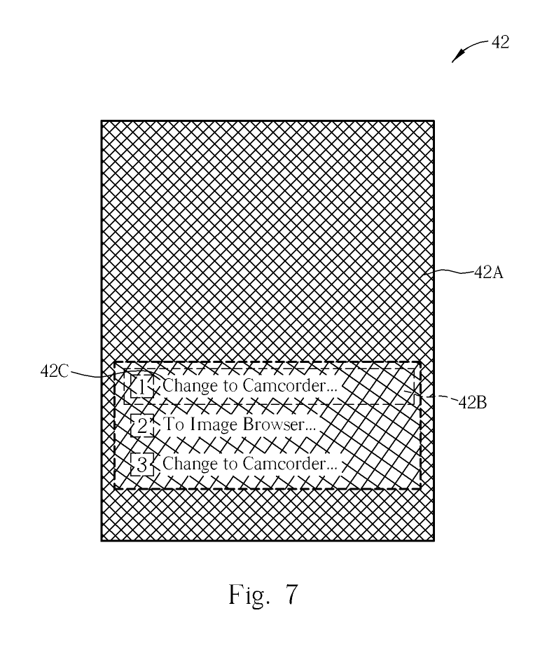

Please refer FIG. 7. FIG. 7 illustrates a screen diagram of a second image 42 according to the present invention. A background 42A of the second image 42 can be a single color, for example a blue color, where its setting is transparent, in other words part of the single color background 42A will be replaced by a camera preview picture, but the second image 42 further comprises a selection 42B with degree of transparency, which can be an interface with functions for a user to execute, a mask value of the selection 42B can be a predetermined value, and the transparency can be determined by the mask value. The selection 42B has writings 42C and the writings 42C can be set to opaque.

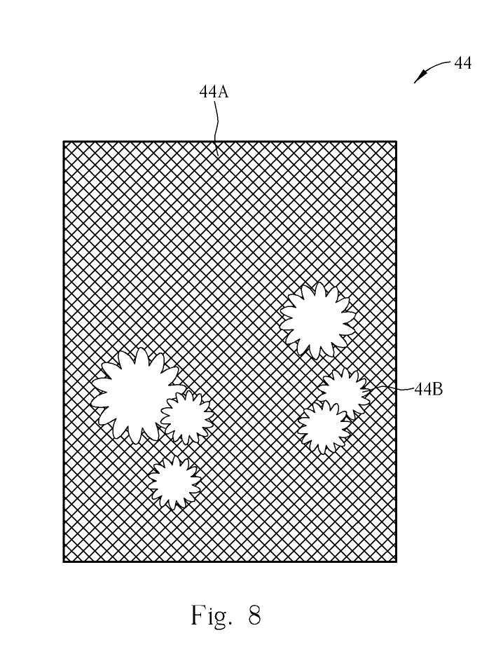

Please refer FIG. 8. FIG. 8 illustrates a screen diagram of a third image 44 according to the present invention. A background 44A of the third image 44 can be a single color, for example a blue color, where its setting is transparent, in other words part of the background 44A will be replaced by a camera preview picture, but the third image 44 further comprises a plurality of small pictures 44B with a degree of opacity, for example a print which can be utilized as a decoration for the image.

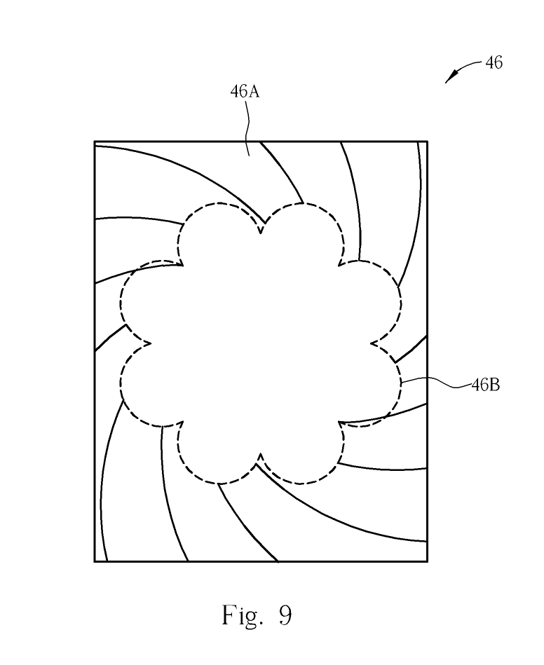

Please refer to FIG. 9. FIG. 9 illustrates a screen diagram of a fourth image 46 according to the present invention. The fourth image 46 is a frame with a mask, part of a frame 46A of the fourth frame 46 is a picture with a degree of opacity, a part of the mask 46B of the fourth image 46 is a mask that has an increasing layer effect, the mask 46B approaching near to the center part is a transparent block with the mask value close to zero, while the mask value of the mask 46B, approaching the edge part and moving away from the center part, becomes greater moving closer to the degree of opacity.

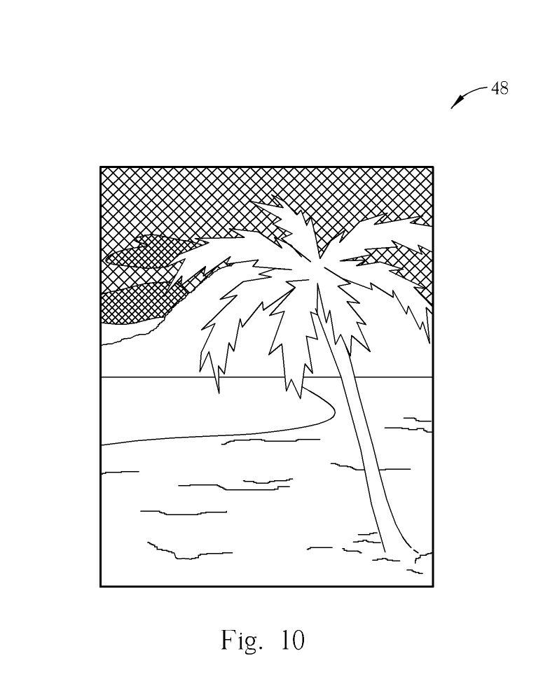

Please refer FIG. 10. FIG. 10 illustrates a screen diagram of a fifth image 48 according to the present invention. The fifth image 48 is an image captured via a digital camera module 36, the fifth image can be a preview image data, or a static captured image photographed.

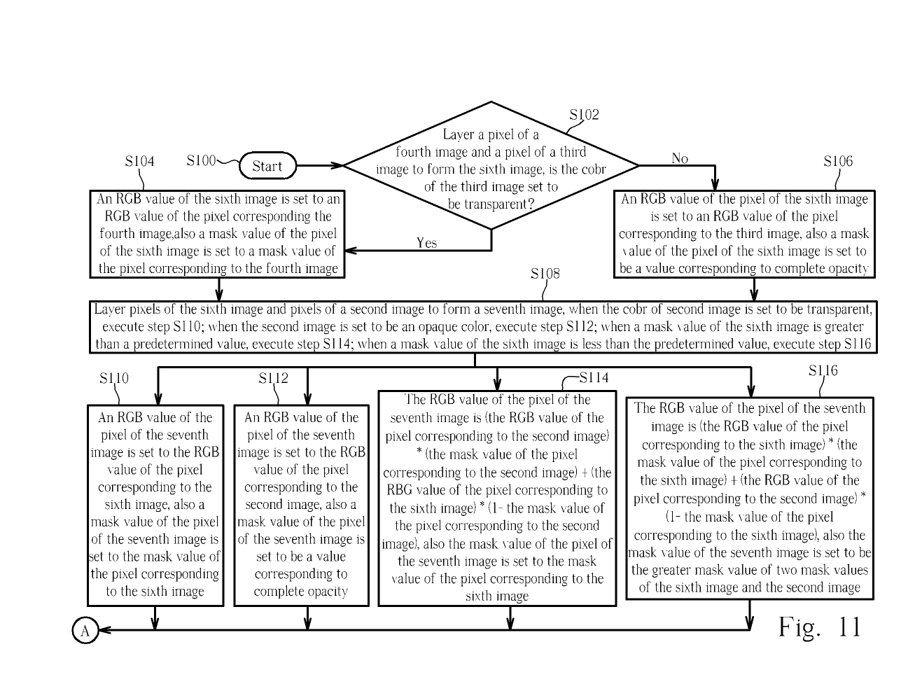

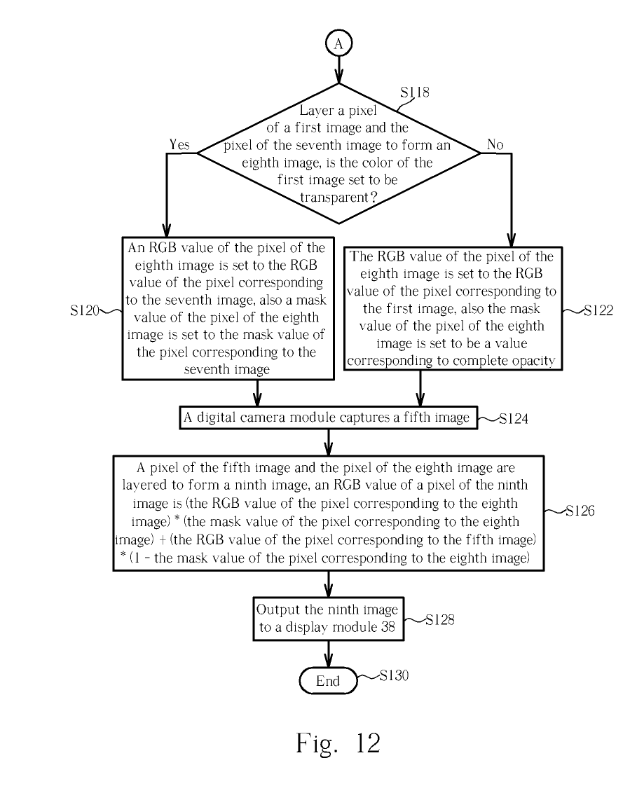

Please refer FIG. 11 and FIG. 12. FIG. 11 and FIG. 12 illustrate flowcharts of processing multi-layered image data according to the present invention. The method comprises the following steps:

Step S100: Start;

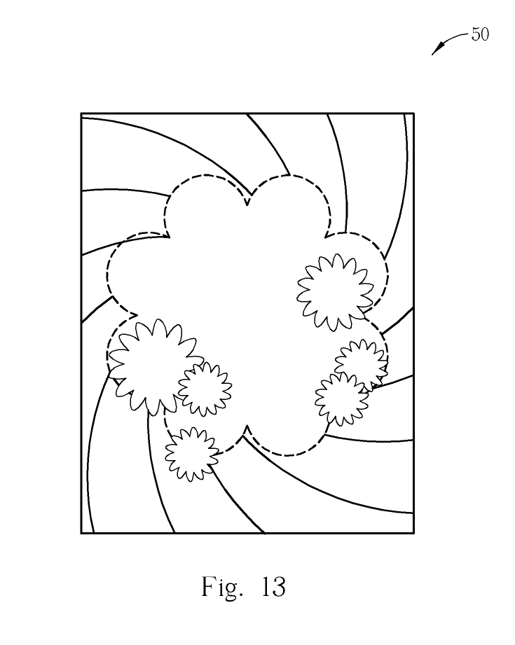

Step S102: Please refer to FIG. 13. FIG. 13 illustrates a screen diagram of a sixth image 50 according to the present invention. A pixel of a fourth image 46 and a pixel of a third image 44 are layered to form the sixth image 50, when the color of the pixel of the third image 44 is set to be transparent, execute step S104; when the color of the pixel of the third image 44 is not set to be transparent, execute step S106;

Step S104: An RGB value of the sixth image 50 is set to an RGB value of the pixel corresponding to the fourth image 46, also a mask value of the pixel of the sixth image 50 is set to a mask value of the pixel corresponding to the fourth image 46;

Step S106: An RGB value of the pixel of the sixth image 50 is set to an RGB value of the pixel corresponding to the third image 44, also a mask value of the pixel of the sixth image 50 is set to be a value corresponding to complete opacity;

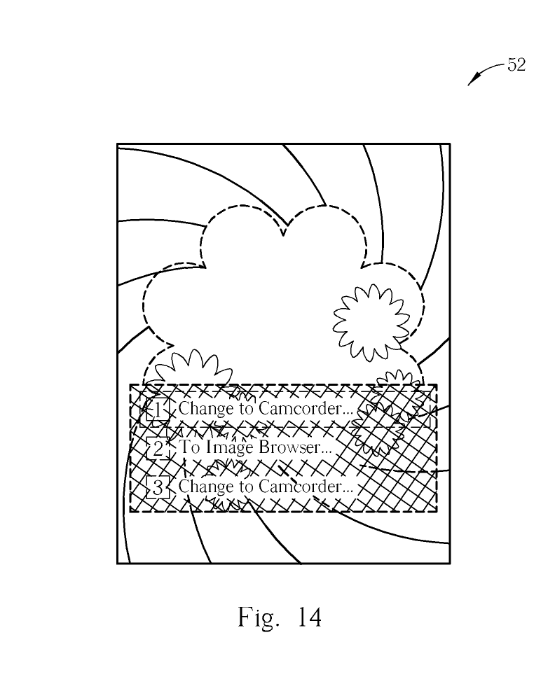

Step S108: Please refer FIG. 14. FIG. 14 illustrates a screen diagram of a seventh image 52 according to the present invention. The pixel of the sixth image 50 and a pixel of a second image 42 are layered to form the seventh image 52, when the color of the pixel of the second image 42 is set to be transparent, execute step S10; when the color of the pixel of the second image 42 is set to be an opaque color, execute step S112; when a mask value of the pixel of the sixth image 50 is greater than a predetermined value, execute step S114; when the mask value of the pixel of the sixth image 50 is less than the predetermined value, execute step S116;

Step S110: An RGB value of the pixel of the seventh image 52 is set to the RGB value of the pixel corresponding to the sixth image 50, also a mask value of the pixel of the seventh image 52 is set to the mask value of the pixel corresponding to the sixth image 50;

Step S112: An RGB value of the pixel of the seventh image 52 is set to the RGB value of the pixel corresponding to the second image 42, also the mask value of the pixel of the seventh image 52 is set to be a value corresponding to complete opacity;

Step S114: The RGB value of the pixel of the seventh image 52 is (the RGB value of the pixel corresponding to the second image 42) * (the mask value of the pixel corresponding to the second image 42)+(the RBG value of the pixel corresponding to the sixth image 50)*(1−the mask value of the pixel corresponding to the second image 42), also the mask value of the pixel of the seventh image 52 is set to the mask value of the pixel corresponding to the sixth image 50;

Step S116: The RGB value of the pixel of the seventh image 52 is (the RGB value of the pixel corresponding to the sixth image 50)*(the mask value of the pixel corresponding to the sixth image 50)+(the RGB value of the pixel corresponding to the second image 42)*(1−the mask value of the pixel corresponding to the sixth image 50), also the mask value of the seventh image 52 is set to be the greater mask value of two mask values of the sixth image 50 and the second image 42;

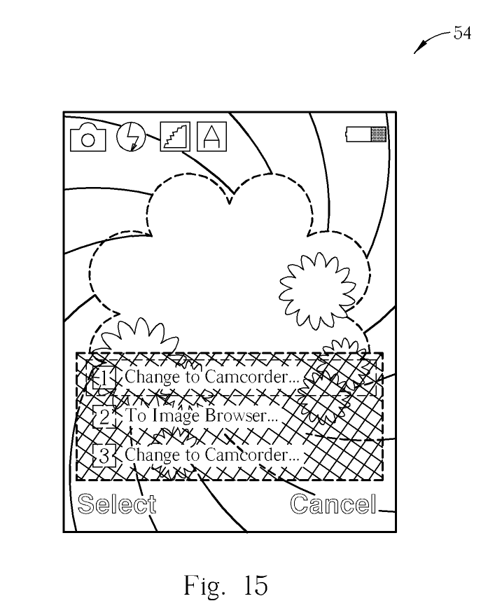

Step S118: Please refer to FIG. 15. FIG. 15 illustrates a screen diagram of an eighth image 54 according to the present invention, a pixel of a first image 40 and a pixel of the seventh image 52 are layered to form the eighth image 54, when the color of the pixel of the first image 40 is set to be transparent, execute step S120; when the color of the pixel of the first image 40 is not set to be transparent, execute step S122;

Step S120: An RGB value of a pixel of the eighth image 54 is set to the RGB value of the pixel corresponding to the seventh image 52, also a mask value of the pixel of the eighth image 54 is set to the mask value of the pixel corresponding to the seventh image 52;

Step S122: The RGB value of the pixel of the eighth image 54 is set to the RGB value of the pixel corresponding to the first image 40, also the mask value of the pixel of the eighth image 54 is set to be a value corresponding to complete opacity;

Step S124: A digital camera module 36 captures a fifth image 48;

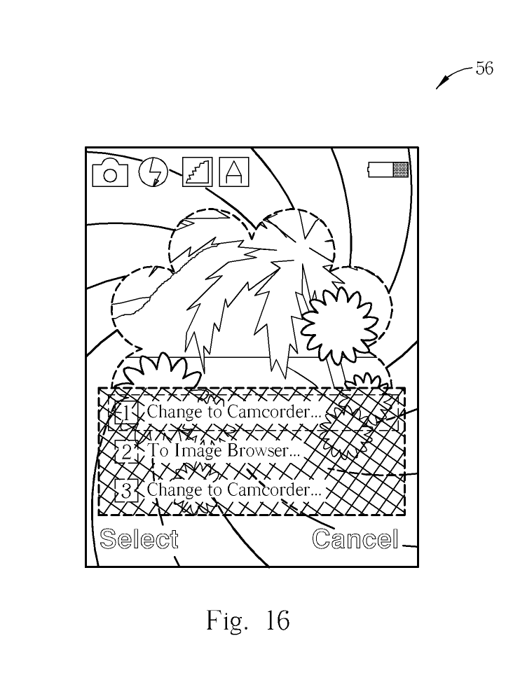

Step S126: A pixel of the fifth image 48 and the pixel of the eighth image 54 are layered to form a ninth image 56, please refer to FIG. 16. FIG. 16 illustrates a screen diagram of a ninth image 56 according to the present invention. An RGB value of a pixel of the ninth image 56 is set to be (the RGB value of the pixel corresponding to the eighth image 54)*(the mask value of the pixel corresponding to the eighth image 54)+(the RGB value of the pixel corresponding to the fifth image 48)*(1−the mask value of the pixel corresponding to the eighth image 54);

Step S128: Output the ninth image 56 to a display module 38;

Step S130: End.

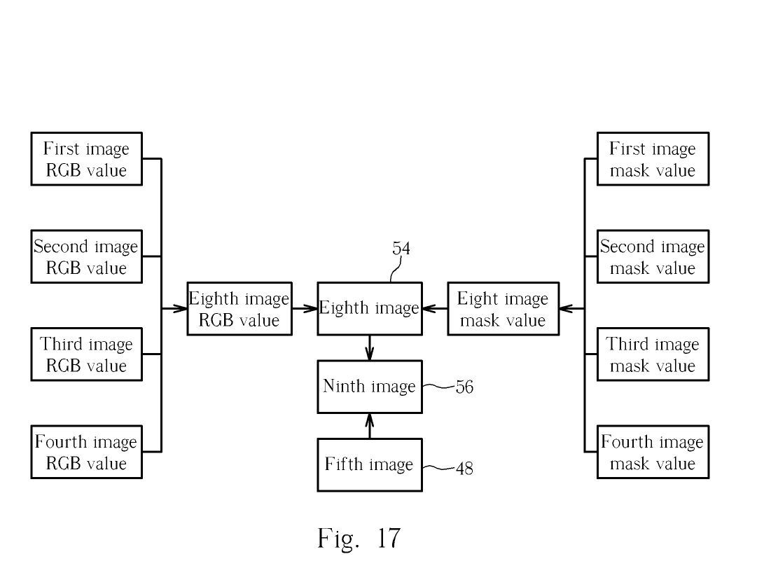

For a more detailed explanation of the above-mentioned steps, please refer to FIG. 17. FIG. 17 illustrates an architecture diagram of the present invention processing multi-layered image data. A first image 40, a second image 42, a third image 44, and a fourth image 46 can combine to form an eighth image 54, and the eighth image 54 will be a foreground image data of the final output image, but the algorithm of the foreground image data is calculated from bottom to top, in other words, the fourth image 46 and the third image 44 are first combined to form a sixth image 50, then the sixth image 50 and the second image 42 are combined to form a seventh image 52, lastly, the seventh image 52 and the first image 40 are combined to form the foreground image data of the eighth image 54.

In the process of layering the pixel of the fourth image 46 and the pixel of the third image 44 to form the sixth image 50, when the color of a pixel of the third image 44 is set to be transparent, for example a blue color, which represents that a portion will be covered by the layered images and FIG. 8 illustrates the background 44A of the third image 44 that is the portion mentioned, a pixel of the background 44A will continue to execute the operation in step S104, at this time as the background 44A is set to be transparent, an RGB value of the pixel of the background 44A corresponding to the generation of the sixth image 50 will be set to be the RGB value of the pixel of the background 44A corresponding to the fourth image 46, also a mask value of the pixel of the background 44A corresponding to the sixth image 50 will be set to be the mask value of the pixel of the background 44A corresponding to the fourth image 46; when the color of the pixel of the third image 44 is not set to be transparent, which also represents a portion will not be covered by the layered images, and FIG. 8 illustrates the picture 44B of the third image 44 that is the portion mentioned, a pixel of the picture 44B will continue to execute the operation in step S106, at this time as the picture 44B is set to be opaque, an RGB value of a pixel of the picture 44B corresponding to the sixth image 50 will be set be the RGB value of the pixel of the picture 44B of the third image 44. In addition, a mask value of the pixel of the picture 44B corresponding to the sixth image 50 is set to be a complete opaque value.

Utilizing the same principle as the above-mentioned, in the process of layering the pixel of the sixth image 50 and the pixel of the second image 42 to form the seventh image 52, when the color of a pixel of the second image 42 is set to be transparent, for example a blue color, which also represents that a portion will be covered by the layered images, and FIG. 7 illustrates the background 42A of the second image 42 that is the portion mentioned, a pixel of the background 42A will continue to execute the operation in step S110, at this time as the background 42A is set to be transparent, an RGB value of the pixel of the background 42A corresponding to the generation of the seventh image 52 will be set to be the RGB value of the pixel of the background 42A corresponding to the sixth image 50, also a mask value of the pixel of the background 42A corresponding to the seventh image 52 will be set to be the mask value of the pixel of the background 42A corresponding to the sixth image 50; when the color of the pixel of the third image 44 is set to be opaque, which also represents that a portion will not be covered by the layered images, and FIG. 7 illustrates letterings 42C of the selection 42B of the second image 42 that is the portion mentioned, a pixel of the letterings 42C will continue to execute the operation in step S112, at this time as the letterings 42C are set to be opaque, an RGB value of the pixel of the letterings corresponding to the seventh image 52 will be set to be the RGB value of the pixel of the letterings 42C corresponding to the second image 42. Also a mask value of the pixel of the letterings 42C corresponding to the seventh image 52 is set to be to a complete opaque value; and the left over portions of the second image 42 are partially transparent pixels, which is at a translucent state, and the selection 42B of the second image 42 in FIG. 7 (not including the letterings 42C) that is the portions mentioned, at this time if a mask value of the pixel of the selections 42B corresponding to the sixth image 50 is greater than the predetermined value (represents transparency is lower), then the RGB value of the pixel of the selection 42B (not including the letterings 42C) corresponding to the seventh image 52 is set to be (the RGB value of the pixel of the selection 42B corresponding to the second image 42)*(the mask value of the pixel of the selection 42B corresponding to the second image 42)+(the RBG value of the pixel of the selection 42B corresponding to the sixth image 50)*(1−the mask value of the pixel of the selection 42B corresponding to the second image 42), also the mask value of the pixel of the selection 42B corresponding to the seventh image 52 is set to be the mask value of the pixel of the selection 42B corresponding to the sixth image 50. But if the mask value of the pixel of the selection 42B corresponding to the sixth image 50 is less than the predetermined value (represents transparency is higher), then the RGB value of the pixel of the selection 42B (not including the letterings 42C) corresponding to the seventh image 52 is set to be (the RGB value of the pixel of the selection 42B corresponding to the sixth image 50)*(the mask value of the pixel of the selection 42B corresponding to the sixth image 50)+(the RGB value of the pixel of the selection 42B corresponding to the second image 42)*(1−the mask value of the pixel of the selection 42B corresponding to the sixth image 50), also the mask value of the pixel of the selection 42B corresponding to the seventh image 52 is set to be the greater mask value of two mask values of the pixel of the selection 42B corresponding to the sixth image 50 and the pixel of the selection 42B corresponding to the second image 42.

Again in the process of layering the pixel of the first image 40 and the pixel of seventh image 52 to form the eighth image 54 of the foreground image data, as the theory and process is similar to layering the pixel of the third image 44 and the pixel of the fourth image 46, when the color of the pixel of the first image 40 is set to be transparent, for example a blue color, which also represents a portion will be covered by the layered images and FIG. 6 illustrates the background 40A of the first image 40 that is the portion mentioned, a pixel of the background 40A will continue to execute the operation in step S120, at this time as the background 40A is set to be transparent, an RGB value of the pixel of the background 40A corresponding to the generation of the eighth image 54 will be set to be the RGB value of the pixel of the background 40A corresponding to the seventh image 52, also a mask value of the pixel of the background 40A corresponding to the eighth image 54 will be set to be the mask value of the pixel of the background 40A corresponding to the seventh image 52; when the color of the pixel of the first image 40 is not set to be transparent, which also represents a portion will not be covered by the layered images, and FIG. 6 illustrates the picture 40B of the first image 40 that is the portion mentioned, a pixel of the picture 40B will continue to execute the operation in step S122, at this time as the picture 40B is set to be opaque, an RGB value of a pixel of the picture 40B corresponding to the eighth image 54 will be set be the RGB value of the pixel of the picture 40B corresponding of the first image 40. In addition, a mask value of the pixel of the picture 40B corresponding to the eighth image 54 is set to be a complete opaque value.

Lastly, the eighth image 54 of the foreground image data is being layered with the fifth image 48 captured by the digital camera module 36, and the RGB value of the ninth image 56 is set to be (the RGB value of the pixel corresponding to the eighth image 54)*(the mask value of the pixel corresponding to the eighth image 54)+(the RGB value of the pixel corresponding to the fifth image 48)*(1−the mask value of the pixel corresponding to the eighth image 54), the ninth image 56 calculated becomes the final image to be represented on the display module 38. And steps S100 to S130 in the above-mentioned can be executed repeatedly, for example, if the image refresh rate is 30 fps (frame/per second), then the logic unit 39 will calculate a ninth image 56 in every 1/30 second to be presented on the display module 38, the user can view the camera preview picture and images generated from the foreground image data on the display module 38.

The embodiment of the present invention can also be applied to an image processing device, such as a digital camera, a PDA, or other handheld electronic devices, the fifth image of the above embodiment is the image not formed by the foreground image data and also it is not limited to the image captured by the digital camera module 36, the fifth image can be an image inputted via any input interface to be layered with the foreground image data stored in the storage device of the present invention.

In comparison with the conventional method for processing multi-layer image data, the method of the present invention processes multi-layer image data by utilizing a modified alpha blending algorithm, and hence a simple software can be utilized to calculate scenes which cannot be effectively processed in the conventional method, for example by adding a shaded diagram or frame to a camera preview picture, or by adding on multi-layered images of shaded diagrams, frames, and translucent selections to the camera preview picture, thus display selection, diagram, special effects, or background can be presented simultaneously on the limited display screen so that more diversified visual effects can be provided to the user to increase the value of the product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing Multi-layered image data comprising:
detecting whether a mask value of a first image data is within a predetermined range; and
generating a third image data when the mask value of the first image data is within the predetermined range according to the first image data, a second image data, and a mask value of the second image data.

2. The method of claim 1 further comprising generating a fourth image data according to the third image data, the mask value of the first image data, and an image.

3. The method of claim 2 further comprising utilizing a mobile communication device to capture the image.

4. The method of claim 2 wherein an RGB value of the fourth image is equal to the product of an RBG value of the third image and the mask value of the first image data added to the product of an RGB value of the image and one minus the mask value of the first image data.

5. The method of claim 1 wherein an RGB value of the third image data is equal to the product of an RGB value of the second image data and a mask of the second image data added to the product of an RGB value of the first image data and one minus the mask value of the second image data.

6. A method for processing Multi-layered image data comprising:
detecting whether a mask value of a first image data is within a predetermined range; and
generating a third image data when the mask value of the first image data is outside the predetermined range according to the first image data, a second image data, and the mask value of the first image data.

7. The method of claim 6 further comprising generating a fourth image data according to the third image data, a greater mask value between two mask values of the first image data, and the second image data and an image.

8. The method of claim 7 further comprising utilizing a mobile communication device to capture the image.

9. The method of claim 7 wherein an RBG value of the fourth image data is equal to the product of an RBG value of the third image data and the greater mask value between two mask values of the first image data and the second image data added to the product of an RGB value of the image and one minus the greater mask value between two mask values of the first image data and the second image.

10. The method of claim 6 wherein an RGB value of the third image data is equal to the product of an RGB value of the first image data and the mask value of the first image data added to the product of an RGB value of the second image data and one minus the mask value of the first image data.

11. A mobile communication device for processing Multi-layered image data comprising:
a memory for storing a first image data and a second image data;
a logic unit coupled to the memory for determining whether a mask value of the first image is within a predetermined range, and for generating a third image data when the mask value of the first image data is within the predetermined range according to the first image data, the second image data, and a mask value of the second image data; and
a display module coupled to the logic unit for displaying an image data.

12. The mobile communication device of claim 11 wherein the logic unit is utilized for generating a fourth image data according the third image data, the mask value of the first image data, and an image.

13. The mobile communication device of claim 12 further comprising a digital camera module for capturing the image.

14. The mobile communication device of claim 12 wherein an RGB value of the fourth image data is equal to the product of an RGB value of the third image data and the mask value of the first image data added to the product of an RGB value of the image and one minus the mask value of the first image data.

15. The mobile communication device of claim 11 wherein an RGB value of the third image data is equal to the product of an RGB value of the second image and a mask of the second image data added to the product of an RGB value of the first image and one minus the mask value of the second image data.

16. A mobile communication device for processing Multi-layered image data comprising:
a memory for storing a first image data and a second image data;
a display module coupled to the memory for displaying an image data; and
a logic unit coupled to the display module for determining whether a mask value of the first image data is within a predetermined range, and for generating a third image data when the mask value of the first image data is outside the predetermined range according to the first image data, the second image data, and the mask value of the first image data.

17. The mobile communication device of claim 16 wherein the logic unit is utilized for generating a fourth image data according the third image data, a greater mask value between two mask values of the first image data and the second image data, and an image.

18. The mobile communication device of claim 17 further comprising a digital camera module for capturing the image.

19. The mobile communication device of claim 17 wherein an RGB value of the fourth image data is equal to the product of an RGB value of the third image data and the greater mask value between two mask values of the first image data and the second image data added to the product of an RGB value of the image and one minus the greater mask value between two mask values of the first image data and the second image.

20. The mobile communication device of claim 16 wherein an RBG value of the third image data is equal to the product of an RGB value of the first image data and the mask of the first image added to the product of an RGB value of the second image data and one minus the mask value of the first image data.

21. An image processing device for processing Multi-layered image data comprising:
a memory for storing a first image data and a second image data;
a logic unit coupled to the memory for determining whether a mask value of the first image is within a predetermined range, and for generating a third image data when the mask value of the first image data is within the predetermined range according to the first image data, the second image data, and a mask value of the second image data; and
a display module coupled to the logic unit for displaying an image data.

22. The image processing device of claim 21 wherein the logic unit is utilized for generating a fourth image data according to the third image data, the mask value of the first image, and an image.

23. The image processing device of claim 22 further comprising a digital camera module for capturing the image.

24. The image processing device of claim 22 wherein an RGB value of the fourth image data is equal to the product of an RGB value of the third image data and the mask value of the first image data added to the product of an RGB value of the image and one minus the mask value of the first image data.

25. The image processing device of claim 21 wherein an RGB value of the third image is equal to the product of an RGB value of the second image data and a mask of the second image data added to the product of an RGB value of the first image data and one minus the mask value of the second image data.

26. An image processing device for processing Multi-layered image data comprising:
a memory for storing a first image data and a second image data;
a logic unit coupled to the memory for determining whether a mask value of the first image data is within a predetermined range, and for generating a third image data when the mask value of the first image data is outside the predetermined range according to the first image data, the second image data, and the mask value of the first image data; and
a display module coupled to the logic unit for displaying an image data.

27. The image processing device of claim 26 wherein the logic unit is utilized for generating a fourth image data according the third image data, a greater mask value between two mask values of the first image data and the second image data, and an image.

28. The image processing device of claim 27 further comprising a digital camera module for capturing the image.

29. The image processing device of claim 27 wherein an RGB value of the fourth image data is equal to the product of an RGB value of the third image data and the greater mask value between two mask values of the first image data and the second image data added to the product of an RGB value of the image and one minus the greater mask value between two mask values of the first image data and the second image data.

30. The image processing device of claim 26 wherein an RGB value of the third image data is equal to the product of an RGB value of the first image data and a mask of the first image data added to the product of an RGB value of the second image data and one minus the mask value of the first image data.
